(19) United States
(12) Patent Application Publication
(10) Pub. No.: US 2018/0245566 A1
(43) Pub. Date: Aug. 30, 2018

(54) Wind Power Generation Device

(71) Applicant: Hitachi, Ltd., Chiyoda-ku, Tokyo (JP)

(72) Inventor: Takahiko SAWADA, Tokyo (JP)

(21) Appl. No.: 15/754,814

(22) PCT Filed: Aug. 24, 2015
(86) PCT No.: PCT/JP2015/073641

§ 371 Date: Feb. 23, 2018

(51) Int. Cl. F03D 1/06; F03D 80/30

(52) U.S. Cl. CPC F03D 1/0675; F03D 80/30; F05B 2280/1021; F05B 2280/50; F05B 2280/6003; F05B 2240/30

(57) ABSTRACT

The object of the present invention is to provide a highly reliable wind power generation device capable of standing a lightning stroke for a long period of time. In order to solve the problem, the wind power generation device related to the present invention includes blades that receive wind and rotate and spar caps that are disposed in the blades and become strength members of the blades, in which skins of the blades are grounded to the outside of the wind power generation device, the skin of the blade and the spar cap are configured of the same or different electro-conductive materials, and the skin of the blade and the spar cap are electrically connected to each other.

### TECHNICAL FIELD

The present invention relates to a wind power generation device, and relates specifically to a wind power generation device that gives consideration to a thunderbolt countermeasure.

### BACKGROUND ART

In general, a wind power generation device has such configuration that a nacelle is supported by the upper part of a tower, and blades attached to a hub are supported by the nacelle so as to be free in the turning direction. The entire rotor including the blades rotates by receiving the wind, and converts the rotation energy to electricity.

The blades used in such wind power generation device are supported by the upper part of the tower. The windmill is damaged by lightning depending on its structure, height and location. Particularly, the blade can be said to have a high risk of damage by a lightning stroke because the blade is disposed at a high position of the upper part of the tower.

When lightning strikes a blade, extremely large current comes to flow through the windmill structure. With respect to the blade in particular, when moisture and bubbles exist within the constituent material, serious damage may be incurred such that the blade is heated instantaneously to cause burnout or explosion. When considerable damage is caused in the blade by a lightning stroke, tremendous time and cost are usually incurred for the repair.

Therefore, the blade has been required to combine light weight, high strength and excellent lightning resistance in a balanced manner. Various measures have been made so far in order to improve lightning resistance of the blade.

As a measure for improving the lightning resistance of the blade for wind power generation, with respect to a windmill blade including a lightning protection system as described in Patent Literature 1, focusing on those in which lightning possibly strikes comparatively small receptor region, a metal foil is disposed at the back of the spar cap in the radial direction, is positioned on the lower side of the outer wing layer, and extends from the root end of the wing toward the tip of the wing along substantial portions of the length of the wing. This is configured with an aim of reducing occurrence of striking of lightning that does not strike the receptor of the lightning protection system.

### CITATION LIST

### Patent Literature

Patent Literature 1: Japanese Unexamined Patent Application Publication No. 2005-113735

### SUMMARY OF INVENTION

### Technical Problem

The metal foil proposed in Patent Literature 1 is made a metal piece whose sheet thickness is sufficiently small compared to the dimension in the longitudinal direction and the transverse direction. Therefore, when lightning strikes the metal foil whose dimension of the sheet thickness is small, it can be said that fracture, meltdown, and burnout of the lightning stroke position are caused and that the protection function gradually deteriorates. Since the metal foil is disposed inside the outer surface of the blade, replacement and repair are not easy, and replacement of entire blade becomes necessary depending on the magnitude of the damage. Also, since operation of the windmill is obliged to stop at the time of such repair and replacement work as described above, there is a problem that electric power generation is unable during the suspension.

Therefore, the object of the present invention is to provide a highly reliable wind power generation device that can stand a lightning stroke for a long period of time.

### Solution to Problem

In order to solve the problem described above, the wind power generation device related to the present invention includes blades that receive wind and rotate, skins of the blades, and spar caps that are disposed in the blades and improve strength of the blades, in which the skins of the blades are connected to the outside of the wind power generation device, the skin of the blade and the spar cap are configured of the same or different electro-conductive materials, and the skin of the blade and the spar cap are electrically connected to each other.

### Advantageous Effect of Invention

According to the present invention, it becomes possible to provide a highly reliable wind power generation device that reduces damage of the blades by a lightning stroke.

### BRIEF DESCRIPTION OF DRAWINGS

FIG. 1 is a representative schematic configuration drawing showing a wind power generation device of a reference example.

FIG. 2 is a schematic drawing showing a blade for wind power generation of the reference example.

FIG. 3 is an A-A′ cross-sectional view in FIG. 2.

FIG. 4 is a representative schematic configuration drawing showing a wind power generation device of the present invention.

FIG. 5 is a schematic drawing of a first embodiment of a blade for wind power generation of the present invention.

FIG. 6 is a B-B′ cross-sectional view in FIG. 5.

FIG. 7 is a cross-section photograph along the fiber direction of carbon-fiber-reinforced aluminum-based composite material.

FIG. 8 is an enlarged perspective view of the part C in FIG. 5.

FIG. 9 is a D-D′ cross-sectional view of the part C in FIG. 8.

FIG. 10 is a schematic configuration drawing explaining a second embodiment in the present invention.

### DESCRIPTION OF EMBODIMENTS

### Reference Example

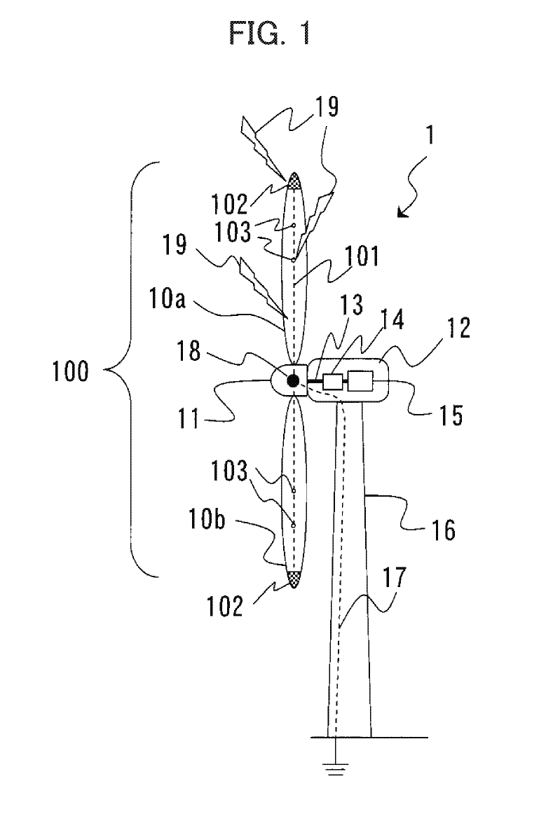

As a reference example, a structure of a wind power generation device will be explained briefly using FIG. 1. A wind power generation device 1 includes a tower 16 that is erected on a base made of ferroconcrete not illustrated arranged on the ground surface for example, a nacelle 12 that is arranged at the upper end of the tower 16, and a rotor head 11 that is rotatably supported around a rotation main shaft 13 and is arranged on the front end side of the nacelle 12, the rotor main shaft 13 being in a generally horizontal lateral direction.

A rotor 100 is configured by attaching plural (three for example) blades 10 to the rotor head 11, the blades 10 extending in the radial direction of the rotor shaft. A generator 15 is accommodated and installed inside the nacelle 12, and the rotor shaft 13 of the rotor head 11 is connected to a main shaft of the generator 15 through a speed increasing gear 14. Therefore, the wind force of the external wind having hit the blades 10 is converted to a rotational force that rotates the rotor head 11 and the rotor shaft 13, and the generator 15 is driven to execute electric power generation.

The nacelle 12 can turn in the horizontal direction at the upper end of the tower 16 along with the blades 10 and the rotor head 11. At an appropriate position (upper part and the like for example) on the outer peripheral surface of the nacelle 12, a vane anemometer not illustrated which measures the wind direction and the wind velocity value of the periphery and a lightning rod for avoiding a lightning stroke 19 are arranged. The nacelle 12 is controlled by a drive device and a control device not illustrated so as to be capable of efficiently generating electric power while the rotor head is constantly directed to the upstream side of the wind in the case of the up-wind system windmill, and while the rotor head is constantly directed to the downstream side of the wind in the case of the down-wind system windmill. Also, the pitch angle of the blades 10 is automatically adjusted so that the windmill rotor blades 10 are rotated most efficiently according to the air volume.

In each blade 10, a lightning receiving section (receptor) 102 is provided at the distal end in order to reduce the damage caused by the lightning stroke 19. Also, intermediate receptors 103 of a circular shape having the diameter of several centimeters are provided so as to be spotted from the distal end of the blade 10 toward the root direction. The receptor 102 and the intermediate receptors 103 are fixed to the distal end and the surface of the blade 10 using an adhesive agent and the like. An interior-blade conductor wire (down conductor) 101 extending from respective receptors is provided so as to go through the inside of the blade 10 and to extend to the blade root side. The down conductors 101 of the respective blades 10 are combined into one line in the inside of the rotor head 11, and are electrically conducted with a tower conductor wire 17 provided within the nacelle 12 and the tower 16 through a slip ring 18 and the like. The lightning rod described above is also conducted with the tower conductor wire 17, and the other end of the tower conductor wire 17 is earthed into the ground.

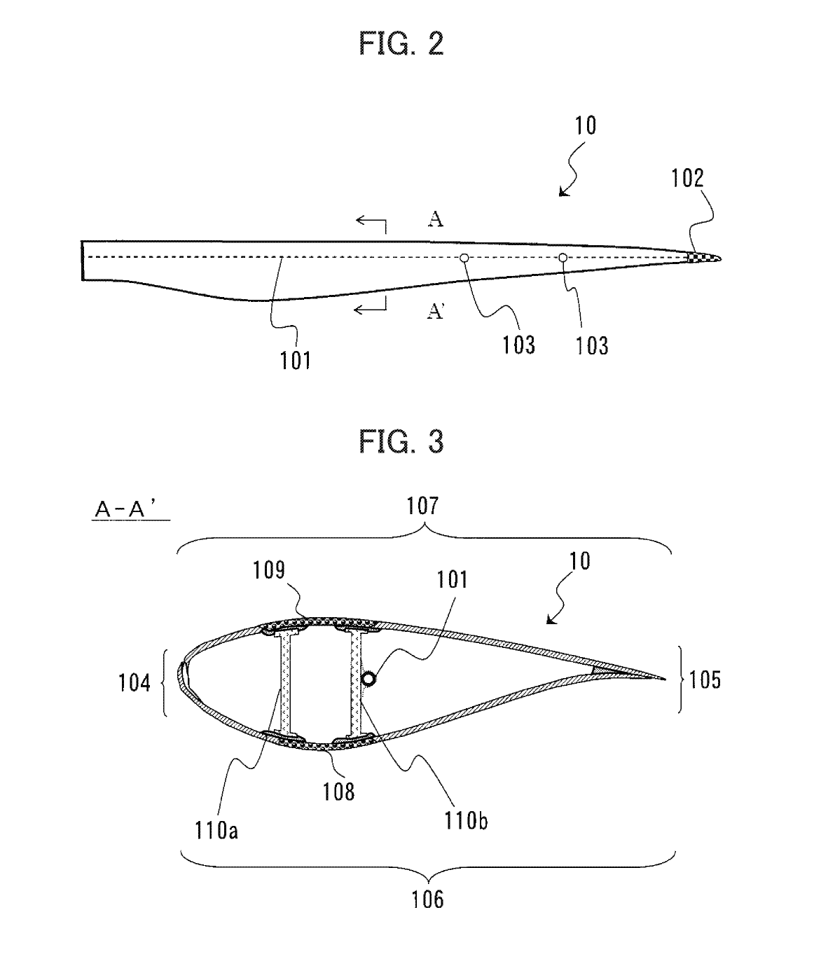

A schematic structure of the blade for wind power generation in a reference example will be explained using FIG. 2. The blade 10 is configured of fiber-reinforced resin composite material (will be hereinafter referred to as FRP) with the base material of a polyester resin and an epoxy resin, and is molded and manufactured by a hand lay-up method, a resin impregnation method, a vacuum impregnation method, an auto-clave method, and the like. Also, the wing shape is formed by joining plural members by an adhesive agent or other joining means. Further, the blade 10 is formed into a wing shape that aero-dynamically secures a rotational force.

As described above, the FRP is used as the material that configures the blade 10, and a carbon fiber and a glass fiber are used as the reinforcement fiber. From the viewpoint of the material cost, the FRP by the glass fiber (GFRP) is commonly used. On the other hand, as the base material resin, an epoxy resin excellent in mechanical property and high in electric resistance is commonly used. Further, with respect also to the FRP by the carbon fiber (CFRP), the use amount is increasing as the structural material of the blade 10 because it is light in weight and can exert the high strength property. The carbon fiber is high in electrical conductivity, and the base material resin can be said to be high in electrical insulation property though not to the extent of the CFRP because it is low in electrical conductivity. Therefore, the blade 10 can be said to be an insulation structure that is configured of high electric resistance material.

The A-A′ cross-sectional view of FIG. 2 is exemplified in FIG. 3. The blade 10 has a hollow structure mainly configured of the outer shell of FRP, and is configured of a leading edge 104 (LE) that is a front edge section, a trailing edge 105 (TE) that is a rear edge section, a pressure side 106 (PS) that is a positive pressure surface, and a suction side 107 (SS) that is a negative pressure surface. Also, a skin surface (shell) is configured of the pressure side 106 and the suction side 107. When the windmill is in operation, since a load for causing bending deformation of the blade 10 to outside the surface (vertical direction in the drawing) is applied, when the inside of the blade 10 is in a hollow state, buckling breakage occurs. Therefore, by arranging a PS side spar cap member 108 and an SS side spar cap member 109 made of a unidirectional fiber-reinforced plastic in the vicinity of the center of the flap (wide width) surface and adhesively joining a beam member (spar web) 110 between the PS side spar cap 108 and the SS side spar cap 109, buckling resistance property is improved. The down conductor 101 is formed so as to be integral with the spar web 110 along with the adhesive agent and the FRP members.

Causes of breakage of the blade 10 by the lightning stroke 19 are internal damage and burning of the FRP configuring the blade 10 and heating or meltdown of the lightning striking part caused by thermal energy and electric energy generated when high current with high voltage flows through the FRP having high electric resistance.

In view of the breakage mechanism of the blade by the lightning stroke 19, although there exists also a wind power generation device including electro-conductive material at the blade distal end where the possibility of lightning strike is high, when the blade surface is in a low electric resistance state and so on by rain drops and the like, lightning possibly strikes the blade main body.

### Example 1

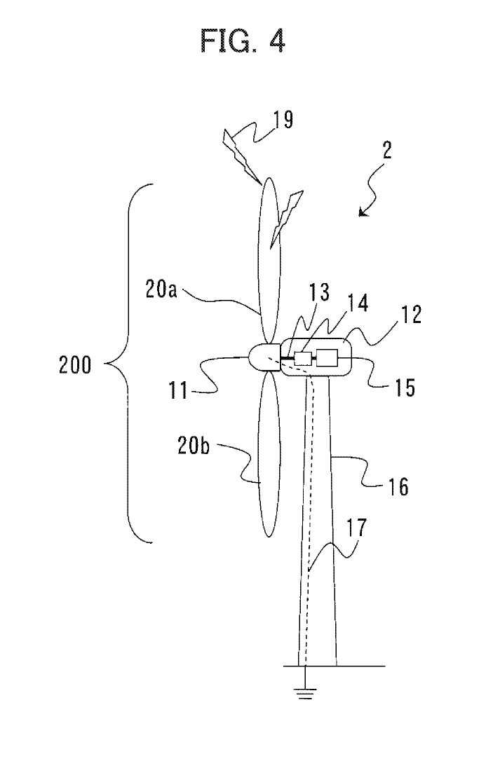

Below, plural examples of the present invention will be explained using plural drawings. FIG. 4 is a representative schematic configuration drawing showing a wind power generation device of the present invention. A wind power generation device 2 of FIG. 4 includes the tower 16 that is erected on a base 3 made of ferroconcrete arranged on the ground surface for example, the nacelle 12 that is arranged at the upper end of the tower 16, and the rotor head 11 that is rotatably supported around a rotation axis 13 and is arranged on the front end side of the nacelle 12, the rotation axis 13 being in a generally horizontal lateral direction.

A rotor 200 is configured by attaching plural (three for example) blades 20 to the rotor head 11, the blades 20 extending in the radial direction of the rotor shaft. The generator 15 is accommodated and installed inside the nacelle 12, and the rotor shaft 13 of the rotor head 11 is connected to a main shaft of the generator 15 through the speed increasing gear 14. Therefore, the wind force of the external wind having hit the blades 20 is converted to a rotational force that rotates the rotor head 11 and the rotor shaft 13, and the generator 15 is driven to execute electric power generation.

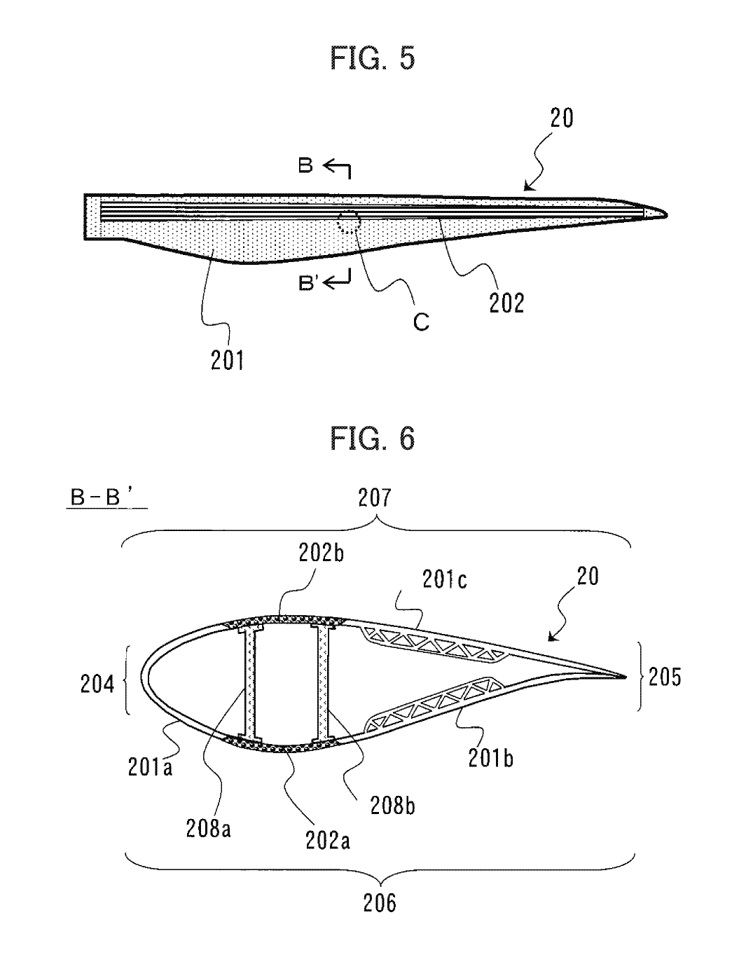

The summary of the blade related to the present embodiment will be explained referring to FIG. 5 and FIG. 6. FIG. 5 is a schematic drawing of a blade related to an embodiment in the present invention, and enlarges and illustrates the blade 20 in the wind power generation device 2 of the present invention shown in FIG. 4. FIG. 6 shows a B-B′ cross-sectional view in FIG. 5.

The blade 20 has a hollow structure mainly configured of an electro-conductive member with low electric resistance, the outer surface of the blade 20 configures a pressure side 206 (PS) that is a positive pressure surface and a suction side 207 (SS) that is a negative pressure surface from a leading edge 204 (LE) that is a front edge section, a trailing edge 205 (TE) that is a rear edge section, and a skin (shell) member 201, and includes electrical connecting means having electrical conductivity and the like for allowing grounding to the outside so that the lightning current is not charged to the body of the blade 20. The electrical connecting means for allowing grounding to the outside may be connected through the blade main body, and is grounded to the outside of the wind power generation device.

When the windmill is in operation, since a load for causing bending deformation of the blade 20 to outside the surface (vertical direction in the drawing) is applied, when the inside of the blade 20 is in a hollow state, buckling breakage occurs. Therefore, by joining a beam member (spar web) 208 so as to straddle over a spar cap 202a and a spar cap 202b arranged in the vicinity of the center of the surface of the blade in the wide width direction (flap direction), buckling resistance property is improved. The spar cap 202b is arranged so as to be embedded in the skin 201 of the blade, and it is configured that the spar cap 202b and the outer surface of the skin 201 of the blade become smooth. At this time, when a buckling resistance property is to be imparted to the shell member 201 and the spar web member 208, although there is a countermeasure of increasing the plate thickness and increasing geometrical moment of inertia, if thick solid material is used, the light weight property of the blade 20 is spoiled. Therefore, with respect to the spar web member 208, a sandwich member is applied which is obtained by changing an electro-conductive member to a foamed member and joining a thin electro-conductive member onto the back surface of the foamed member, and thereby both of the light weight property and the buckling resistance property are fulfilled. Further, in the present example, the spar web is also made electro-conductive, and the effect of improving buckling resistance property and electric conductivity is secured. With respect to the shell member 201, by forming a hollow thick structural member 201c having a thickness larger than that of the other part in the skin 201 of the blade using an extrusion die molding method that is a known technology configured of a sandwich member or an electro-conductive member, buckling resistance performance against the bending load toward the flap direction can be effectively improved without deteriorating the light weight property of the structural member. In the present example, the hollow thick structural member is also made electro-conductive, and the effect of improving weight reduction and electric conductivity is secured.

The electro-conductive member configuring the blade 20 is preferably a metal material, is more preferably a light metal material whose specific gravity is equal to or less than that of the FRP material, and is aluminum or aluminum alloy in concrete terms. In the present description, the aluminum material is to include both of aluminum and aluminum alloy. As the aluminum alloy, known one can be used, and aluminum-copper, aluminum-zinc, aluminum-manganese, aluminum-magnesium, aluminum-magnesium-manganese, aluminum-magnesium-silicon, aluminum-silicon, aluminum-copper-magnesium, aluminum-zinc-magnesium, aluminum-zinc-magnesium-copper, and the like can be cited for example.

In view of the fact that a high material strength property is required for a spar cap 202 that is a structural strength member of the blade 20, it is preferable that the spar cap 202 is configured of a member whose strength and elastic modulus are higher than those of the electro-conductive member. To be more specific, it is preferable that the spar cap 202 is configured of fiber-reinforced material. Further, since lightning possibly strikes the spar cap also directly, it is preferable that the spar cap 202 is configured of an electro-conductive member. In concrete terms, it is preferable to be configured of a fiber-reinforced metal-based composite material, more preferably a carbon fiber-reinforced aluminum metal-based composite material which is obtained by reinforcing aluminum by the carbon fiber. The reason is that light weight and a high electro-conductive effect can be expected with this material. Here, the electro-conductive member of the spar cap and the spar web may be same, or may be different from each other.

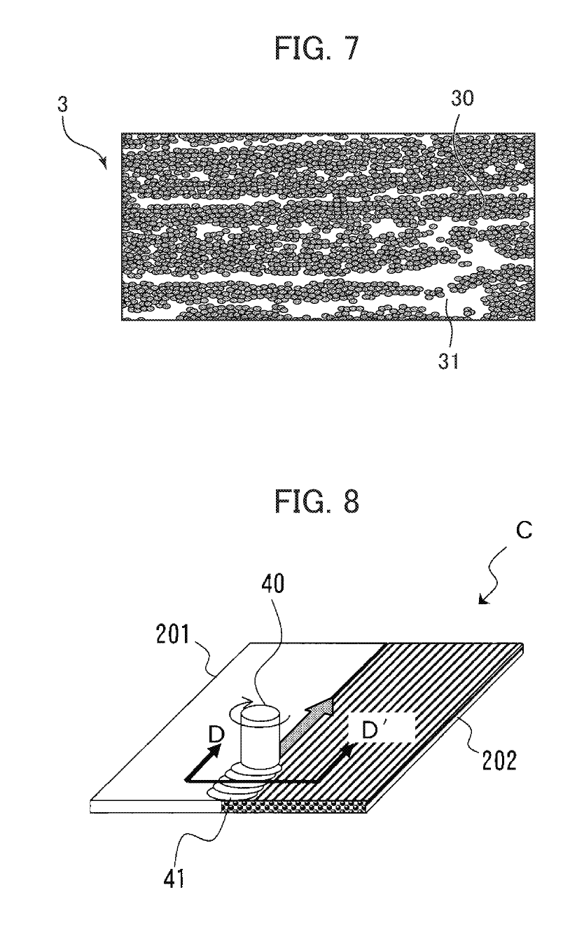

FIG. 7 is a microscopic observation photograph 3 of a cross-section along the fiber direction of a carbon fiber-reinforced aluminum-based composite material, and such condition can be noticed that cross sections of a carbon fiber 30 are spotted within aluminum 31 that becomes the base material. As the carbon fiber used for the reinforcement fiber, a pitch-based carbon fiber obtained by carbonizing a fiber that is obtained from the material of coal tar and a heavy component of petroleum or a carbon fiber obtained by carbonizing polyacrylonitrile is used. With respect to the polyacrylonitrile-based carbon fiber, at the time of compositing with molten aluminum, an interfacial reaction occurs between aluminum of a constant temperature and the carbon fiber, the carbon fiber deteriorates, the mechanical strength lowers, and therefore such known technology may be applied that the surface of the carbon fiber is subjected to alumina ceramics coating to suppress the interfacial reaction. Also, the reinforcement fiber only has to have a melting point higher than that of the base metal, is not limited by the kind of the material, and may use a boron fiber, alumina fiber, tyranno fiber, glass fiber, and the like in addition to a carbon fiber. In the case of the same material, there is an advantage of a case described below.

With respect to the manufacturing method of the carbon fiber-reinforced metal-based composite material, a textile for example obtained using a known weaving machine using a carbon fiber for the warp and/or woof can be used as a preliminary molded body. Also, it is possible to lay carbon fiber layers within a die in one direction or in desired direction to have a desired plate thickness to be used as a preliminary molded body, the die becoming a desired shape. Impregnation of the molten metal of the base metal to the preliminary molded body thus obtained can be executed by a procedure such as the molten metal forging method disclosed in Japanese Unexamined Patent Application Publication No. 2005-82876 for example. The base metal used as the molten metal is aluminum or aluminum alloy. As the aluminum alloy, known one can be used, and aluminum-copper, aluminum-zinc, aluminum-manganese, aluminum-magnesium, aluminum-magnesium-manganese, aluminum-magnesium-silicon, aluminum-silicon, aluminum-copper-magnesium, aluminum-zinc-magnesium, aluminum-zinc-magnesium-copper, and the like can be cited for example. The base metal may be selected appropriately according to the use of the fiber reinforcement metal obtained, and so on.

Although members configuring GFRP-made blades of prior arts are joined by means such as an adhesive agent, an assembling method not using an adhesive agent is preferable from the viewpoint that repair work is difficult because adhered parts are arranged inside in addition to that an adhesive agent formed of resin material temporally deteriorates.

FIG. 8 is a drawing exemplifying a state that the metal member 201 and the spar cap member 201 are subjected to frictional stir welding using a joining tool 40 in a range C surrounded by the dotted line in FIG. 5. Shell members 201a to 201c and the spar cap members 202a, 202b configuring the blade 20 are connected to each other by frictional stir welding.

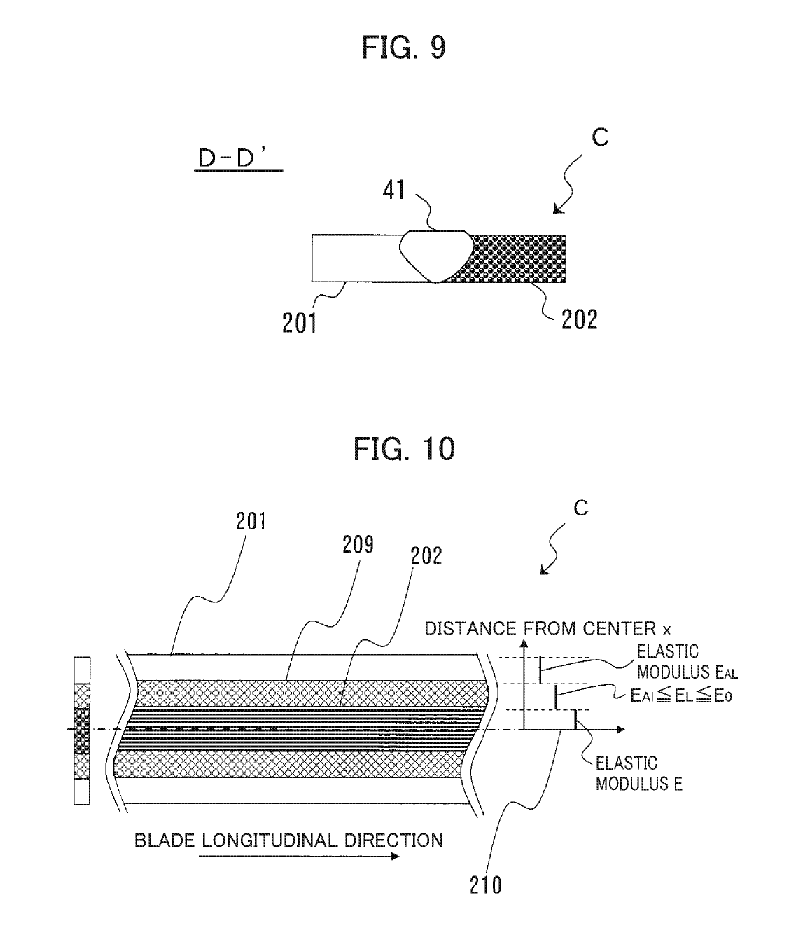

FIG. 9 is a drawing exemplifying a D-D′ cross section in FIG. 8, and exemplifies a state that the metal member 201 and the base metal configuring the member 202 are stirred and continuously joined by the friction heat by rotation of the joining tool 40 by a frictional stir welding section 41. The metal contains metal because the metal itself is metal in the first place, and the joining strength is improved by making the spar cap member 202 also contain metal of the same kind. Therefore, the metal member and the spar cap member 202 can secure more preferable joining strength by containing metal of a same kind. Also, the present embodiment is not limited to joining of the metal member 201 and the spar cap 202, and can be applied to positions for joining ends of all components configuring the blade 20 such as the spar cap members 202a, 202b and spar web members 208a, 208b in FIG. 6 for example. Further, according to the frictional stir welding of the present example, the blade 20 can be connected in an arbitrary order, inspection of the joining section at the time of manufacturing becomes easy, and therefore the blade can be assembled with high quality.

Although there is also a wind power generation device in which an electro-conductive coating is provided on the skin of the blade, there is a case where the electro-conductive coating is damaged by a lighting stroke. Therefore, at the location where the protective function is lost, the FRP material having high electric resistance is exposed, and the electric circuit is lost in the periphery of the location. When lightning strikes again the vicinity of the location where the circuit has been lost, because there is no electric current route to the down conductor, the vicinity of the lightning stroke position comes to be damaged or molten down. Therefore, it is not easy to keep the effect of effectively suppressing the damage of the main strength members for a long period of time.

The present example is a wind power generation device including the blades 20 that receive wind and rotate, the skins 201 of the blades, and the spar caps 202a that are arranged in the blades 20 and improve the strength of the blades 20, in which the skins 201 of the blades are connected to the outside of the wind power generation device, the skin 201 and the spar cap 202a of the blade are configured of the same or different electro-conductive materials, the skin 201 and the spar cap 202a of the blade are electrically connected to each other, and it is possible to provide a highly reliable wind power generation device that can stand a lightning stroke for a long period of time.

### Example 2

A second embodiment of the blade in the present invention will be explained using FIG. 5 and FIG. 10. FIG. 10 shows the second aspect of the range C surrounded by a dotted line in FIG. 5, and has a relationship 210 in which the elastic modulus in the longitudinal direction of the blade gradually reduces from the center in the width direction of the spar cap member 202 toward the width direction of the blade 20. In other words, between the metal member 201 and the spar cap member 202, a fiber-reinforced metal member 209 is disposed which has a blade longitudinal direction elastic modulus E_{L} between an elastic modulus E_{AL} of the metal member 201 and a blade longitudinal direction elastic modulus E₀ of the spar cap member 202. The member 209 having the blade longitudinal direction elastic modulus in between means a member where the fiber direction in the spar cap member 202 has been changed. The word “disposed” used here means to be intentionally disposed in order to be distinguished from a layer formed when both members are mixed each other naturally by frictional stir welding. Since the difference of the elastic modulus between the metal member 201 and the spar cap member 202 is large, according to the present embodiment, the damage of the joining interface can be effectively prevented which is attributable to occurrence of a large strain by an external force caused by abrupt change of the elastic modulus at a discontinuous section, or to occurrence of the thermal stress, and so on. Also, it is not necessary that the member 209 disposed in between is single. By disposing a member in which the orientation direction of the fiber is changed by a classic lamination theory and the like for example and the elastic modulus is changed so as to have plural different Young's moduli for example, the difference of the elastic modulus at the discontinuous section becomes small, and smoother elastic modulus change 209 is exhibited. Also, the present example is not limited to the joining position of the metal member 201 and the spar cap member. By application to a location where the elastic modulus change becomes large, the structural reliability of the blade 20 can be further improved.

### LIST OF REFERENCE SIGNS

1 Wind power generation device
10 Blade
11 Rotor head
12 Nacelle
13 Rotation main shaft
14 Speed increasing gear
15 Generator
16 Tower
17 Tower conductor wire
18 Slip ring
19 Lightning stroke
100 Roller
101 Down conductor
102 Distal end receptor
103 Intermediate receptor
104 Front edge section (LE; leading edge)
105 Section (TE; trailing edge)
106 Pressure surface (PS; pressure side)
107 Pressure surface (SS; suction side)
108 FRP-made PS-side spar cap member
109 FRP-made SS-side spar cap member
110a, 110b Spar web member
2 Device
20a, 20b Blade related to embodiment of invention
200 Rotor provided with blades of invention
201 Shell member related to embodiment of invention
202 Spar cap member related to embodiment of invention
204 Front edge section (LE; leading edge) of blade related to embodiment of invention
205 Rear edge section (TE; trailing edge) of blade related to embodiment of invention
206 Positive pressure surface (PS; pressure side) of blade related to embodiment of invention
207 Negative pressure surface (SS; suction side) of blade related to embodiment of invention
208a, 208b Spar web member related to embodiment of invention
209 Member having blade longitudinal direction elastic modulus in between
210 Example of correlation between elastic modulus and distance at joining section of spar cap member and shell member in second embodiment of invention
3 Microscopic observation photograph of cross section in fiber direction of carbon fiber-reinforced aluminum-based composite material
30 Carbon fiber
31 Aluminum base material
40 Joining tool
41 Frictional stir welding section

1. A wind power generation device, comprising:
blades that receive wind and rotate; and
spar caps that are disposed in the blades and become strength members of the blades,
wherein skins of the blades are grounded to the outside of the wind power generation device,
the skin of the blade and the spar cap are configured of the same or different electro-conductive materials, and
the skin of the blade and the spar cap are electrically connected to each other.

2. The wind power generation device according to claim 1, wherein the spar cap is formed of a fiber-reinforced material.

3. The wind power generation device according to claim 1, wherein the electro-conductive material of the spar cap is a carbon fiber-reinforced composite material with an electro-conductive member as a base material.

4. The wind power generation device according to claim 3, wherein the electro-conductive material is an aluminum material.

5. The wind power generation device according to claim 1, wherein a member having an elastic modulus between an elastic modulus of the skin of the blade in the longitudinal direction of the blade and an elastic modulus of the spar cap in the longitudinal direction of the blade is disposed between the skin of the blade and the spar cap.

6. The wind power generation device according to claim 5, wherein the member having an elastic modulus between an elastic modulus of the skin of the blade in the longitudinal direction of the blade and an elastic modulus of the spar cap in the longitudinal direction of the blade is a fiber-reinforced metal member.

7. The wind power generation device according to claim 1, wherein the electro-conductive material is configured of an aluminum material.

8. The wind power generation device according to claim 1,
wherein the spar caps are disposed on a positive pressure surface and a negative pressure surface of the blade,
spar webs connecting the spar cap disposed on the positive pressure surface of the blade and the spar cap disposed on the negative pressure surface of the blade are further provided, and
the spar webs are configured of an electro-conductive material.

9. The wind power generation device according to claim 8, wherein the spar cap is configured of an electro-conductive foaming member.

10. The wind power generation device according to claim 8, wherein the spar webs are configured of an aluminum material.

11. The wind power generation device according to claim 1, wherein the skin of the blade has a hollow thick structure, and the thickness of the thick structure is thicker than the thickness of positions other than the thick structure in the skin of the blade.

12. The wind power generation device according to claim 11, wherein the thick structure is configured of an electro-conductive foaming member.

13. The wind power generation device according to claim 1, wherein the electro-conductive spar caps are disposed so as to be embedded in the skin of the blade and it is configured that the spar cap and the outer surface of the skin become smooth.

14. The wind power generation device according to claim 1, wherein the skin of the blade and the spar cap contain metal of the same kind, and are joined to each other.
